(19) United States
(12) Patent Application Publication
(10) Pub. No.: US 2013/0020874 A1
(43) Pub. Date: Jan. 24, 2013

(54) PORTABLE SOLAR POWER AND BATTERY CHARGER SYSTEM

(71) Applicants: Keith Ayotte, Hudson, NH (US); Paul Lagasse, Derry, NH (US); David Martin, Londonderry, NH (US); Anthony Sorrentino, Fitchburg, MA (US); Mark Wheeler, Devens, MA (US)

(72) Inventors: Keith Ayotte, Hudson, NH (US); Paul Lagasse, Derry, NH (US); David Martin, Londonderry, NH (US); Anthony Sorrentino, Fitchburg, MA (US); Mark Wheeler, Devens, MA (US)

(21) Appl. No.: 13/552,643

(22) Filed: Jul. 19, 2012

Related U.S. Application Data
(60) Provisional application No. 61/509,311, filed on Jul. 19, 2011.

(51) Int. Cl. H02J 7/00

(52) U.S. Cl. 307/66

(57) ABSTRACT

A portable solar power and battery charger system configured to provide power to accessories and recharge batteries for example concurrently, with automatic switch over to batteries in a prioritized manner from multiple input sources, for example in the case of loss of sunlight and for example with the capability of orienting and aligning a solar panel regardless of available sunlight at setup time.

This application claims the benefit of U.S. Provisional Patent Application 61/509,311 filed on 19 Jul. 2011, the specification of which is hereby incorporated herein by reference.

### BACKGROUND OF THE INVENTION

1. Field of the Invention

Embodiments of the invention described herein pertain to the field of solar power and battery chargers. More particularly, but not by way of limitation, these embodiments enable a portable solar power and battery charger system configured to provide power to accessories and recharge batteries for example concurrently, with automatic switch over to batteries in the case of loss of sunlight and for example with the capability of orienting and aligning a solar panel regardless of sunlight.

2. Description of the Related Art

Devices that require electrical power and which cannot couple to a utility provided power source must obtain power from an external source. One external source is a generator. Another source is an external battery. Yet another source is a solar panel. The problem with a generator is size and the requirement for fuel. This limits this configuration to non-portable scenarios for the most part. The problem with external batteries is that after they are exhausted, they can no longer provide power. The problem with a solar panel is that it only produces power when there is sunlight.

Known solutions exist which combine a solar panel with a battery to provide a portable power solution. Other known solutions exist to attempt to physically move large solar arrays based to track the sun.

### BRIEF SUMMARY OF THE INVENTION

Embodiments of the invention provide a portable solar power and battery charger system. By collapsing the solar panel, it may be readily carried by hand along with embodiments of the system. For example, embodiments of the invention may be stored in a common carry-on bag for an airplane. The system may be used in remote locations with manually assisted setup for orientation and inclination to enable setup of the solar panel at night or in weather conditions where the sun is not visible.

The system includes the main components of the battery charger that obtains power from a solar panel via an electrical line to charge at least one battery. The solar panel and/or at least one battery is/are utilized to provide power via an electrical line to any desired accessory (meaning one or more accessories as desired). When the sun is not providing power to the solar panel, at least one battery is utilized to power accessory. When the sun is providing power via the solar panel, then the power may be utilized by the system to charge at least one battery and/or power any desired accessory. Embodiments of the solar panel may include a magnetometer and inclinometer (or any suitable combined device for example), to enable the system to indicate the desired orientation and inclination of the solar panel regardless of the time of day or position of the sun for example.

Embodiments of the system generally include a power sensing circuit, at least one battery charging circuit electrically coupled with the power sensing circuit wherein the at least one battery charging circuit is configured to electrically couple with at least one battery respectively. The system may further include a summed voltage bus coupled with the at least one battery charging circuit wherein the summed voltage bus is configured to enable the at least one battery to provide power in case of loss of solar power. The system also includes a second power sensing circuit electrically coupled with the summed voltage bus and a direct current to direct current switching voltage regulator coupled with the summed voltage bus. The system utilizes at least one processor coupled with the direct current to direct current switching voltage regulator wherein the at least one processor is configured to control the direct current to direct current switching voltage regulator.

One or more embodiments include a temperature sensor configured to provide a temperature value wherein the processor is configured to control the at least one battery charging circuit based on the temperature value. This allows for optimal charging so as to not damage the batteries and or to maximize battery life associated with any battery being charged by the system.

One or more embodiments may include at least one GPS (Global Positioning Satellite) receiver coupled with the processor. The GPS receiver allows for the determination of the location of the system and hence, allows for the determination of the latitude of the system and time of year, which allows for example for a maximum power inclination for the solar panel to be calculated. In addition, the system may include an interface configured to couple with the solar panel that includes a magnetometer and an inclinometer, wherein the processor is configured to utilize time and position information from the GPS receiver, and orientation information from the magnetometer and inclination information from the inclinometer in order to indicate the desired orientation and inclination to set solar panel for maximum power. This capability is independent of the amount of sunlight available at the time of setup, e.g., the system may be set up at night or in weather where the position of the sun is not readily determinable.

### BRIEF DESCRIPTION OF THE DRAWINGS

FIG. 1 shows an overall logical view of the system.

FIG. 2 shows a logical view of the main components of the system.

FIG. 3 shows a detailed architectural view of the circuitry of the system.

### DETAILED DESCRIPTION OF THE INVENTION

Embodiments of the invention provide a portable solar power and battery charger system. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Any mathematical references made herein are approximations that can in some instances be varied to any degree that enables the invention to accomplish the function for which it is designed. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

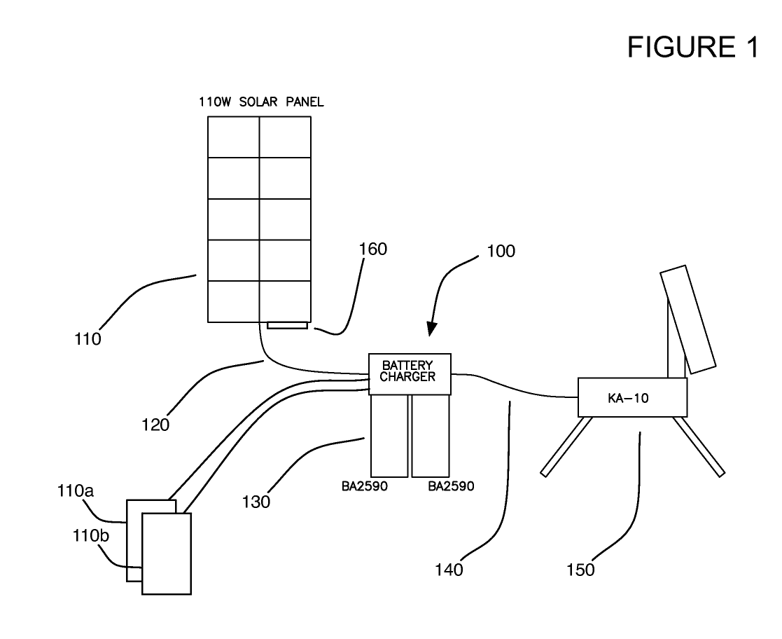

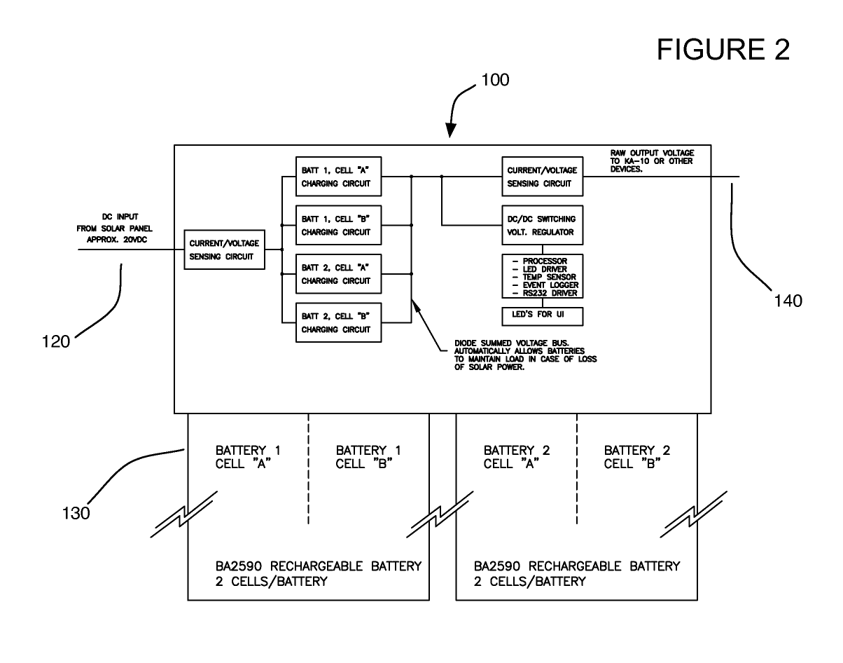

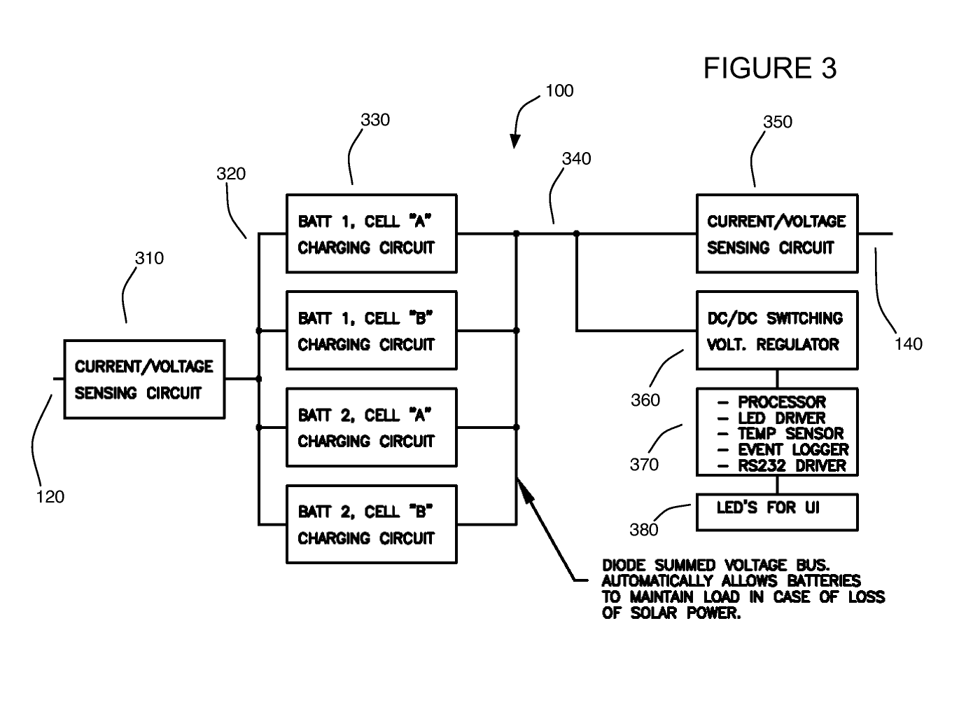

FIG. 1 shows an overall logical view of the system. System 100 includes the main components of the battery charger that obtains power from solar panel 110 via electrical line 120 to charge at least one battery 130. Solar panel 110 and/or at least one battery 130 is/are utilized to provide power via electrical line 140 to accessory 150. More than one solar panel 110 may be coupled to system 100, for example in parallel to increase the available power, however this is not shown for brevity. When the sun is not providing power to solar panel 110, at least one battery 130 is utilized to power accessory 150. When the sun is providing power via solar panel 110, then the power may be utilized by the system to charge at least one battery 130 and/or power accessory 150. Embodiments of the solar panel may include a magnetometer and inclinometer 160 (or any suitable combined device for example), to enable system 100 to indicate the desired orientation and inclination of solar panel 110 regardless of the time of day or position of the sun for example. This allows for manual set up of the orientation and inclination of solar panel 110 without sunlight, i.e., in the dark if desired. Alternate power sources 110a and 110b for example non-rechargeable batteries or AC or DC generator or power supply respectively may be selected to power accessory 150 in a prioritized manner. For example AC or DC generator or power supply 110b may be utilized first in priority after which non-rechargeable batteries 110a may be utilized, followed by solar panel 110 followed by at least one battery 130. Any other priority order may also be utilized and programmed into the processor described with respect to FIGS. 2 and 3 below.

FIG. 2 shows a logical view of the main components of system 100, namely charging circuitry, input line 120 from the solar panel, which may include communication interfaces for obtaining orientation and inclination from magnetometer and inclinometer 160 for example. In addition, the main charging unit of system 100 is shown coupled with two batteries 130 having two cells each. The output of system 100 is used to power any desired accessories and any number of interface types may be utilized for output line 140.

FIG. 3 shows a detailed architectural view of the circuitry of the system. Embodiments of the system generally include power sensing circuit 310, at least one battery charging circuit 330 (here four are shown, one for each cell of each battery to be charged), wherein the at least one battery charging circuit 330 is electrically coupled with power sensing circuit 310. The at least one battery charging circuit 330 is configured to electrically couple with at least one battery respectively (see FIG. 2 for example). Charging circuit 330 may be implemented as a LINEAR TECHNOLOGY® LT3652HV monolithic 4.95V to 34V battery charger chip or any other suitable battery charger as desired. In one or more embodiments of the invention, the charging circuitry may be “ganged” together in any manner to provide charging and power capabilities as desired. For example, as one skilled in the art will appreciate, system 100 in FIG. 2 may utilize one or more circuits as shown in FIG. 3 in parallel as desired to provide more power to the batteries from one or more solar panel. In other embodiments, one solar panel may be coupled to one or more embodiments of the system to charge multiple sets of batteries from only one solar panel. The system may further include a summed voltage bus 340 coupled with at least one battery charging circuit 330 wherein summed voltage bus 340 is configured to enable the at least one battery to provide power in case of loss of solar power. System 100 also includes second power sensing circuit 350 electrically coupled with summed voltage bus 340 and direct current to direct current switching voltage regulator 360 coupled with summed voltage bus 340. Voltage regulator 360 may be implemented as a LINEAR TECHNOLOGY® LTM4607 high efficiency switching mode buck-boost power supply or any other suitable direct current to direct current regulator as desired. System 100 utilizes at least one processor 370 coupled with direct current to direct current switching voltage regulator 360 wherein at least one processor 370 is configured to control direct current to direct current switching voltage regulator 360. One or more embodiments of the invention may provide a direct current voltage regulator external to the charging circuitry shown in FIG. 3, for example coupled externally to electrical line 140. This lessens the heat generated within system 100. This also allows for the greatest level of flexibility in allowing accessories with many different interfaces to couple with system 100. In addition, electrical line 120 may couple with an auxiliary direct current input port of any interface type (not shown for brevity) to allow for non-rechargeable batteries to be utilized for input power. For example, if there non-rechargeable batteries are available, they may be coupled to the system to completely discharge them before they are discarded. In this manner, any remaining charge in the batteries may be utilized by the system to maximize efficiency of power transfer to batteries 130 or accessory 150. This direct current input port may also be utilized by the system in a priority fashion to allow the system to interface with an alternating current to direct current energy source, e.g., a generator or voltage outlet, etc., and use energy from that source first before utilizing batteries 130. Non-rechargeable batteries may be utilized in priority before said batteries 130 for example. Processor 370 can interface with any desired interface. As shown processor 370 can interface with an LED UI or light emitting diode user interface. This is shown a LED Driver associated with processor 370 and LED's for UI or user interface 380 in the figure. One or more embodiments of the user interface accept user inputs that allow system 100 to set the output voltage on electrical line 140 for example. Other user interface elements such as current load and percentage and/or time of expected battery life may also be shown on the user interface 380.

One or more embodiments include a temperature sensor (shown as part of element 370 for brevity) configured to provide a temperature value wherein the processor is configured to control at least one battery charging circuit 330 based on the temperature value. This allows for optimal charging so as to not damage the batteries and or to maximize battery life associated with any battery being charged by the system.

One or more embodiments may include at least one GPS receiver coupled with the processor (not shown for brevity, but coupled electrically or wirelessly to processor 370). The GPS receiver allows for the determination of the location of the system and hence, allows for the determination of the latitude of the system and time of year, which allows for example for a maximum power inclination for the solar panel to be calculated. In addition, the system may include an interface configured to couple with the solar panel that includes a magnetometer and an inclinometer 160, wherein the processor is configured to utilize time and position information from the GPS receiver, and orientation information from the magnetometer and inclination information from the inclinometer in order to indicate the desired orientation and inclination to set solar panel for maximum power. This capability is independent of the amount of sunlight available at the time of setup, e.g., the system may be set up at night or in weather where the position of the sun is not readily determinable. Other embodiments of the invention may utilize small form factor components including a foldable solar panel 110 that allows for a single self contained portable, “grab and go” package.

Thus embodiments of the invention directed to a portable solar power and battery charger system have been exemplified to one of ordinary skill in the art. The claims, however, and the full scope of any equivalents are what define the metes and bounds of the invention.

What is claimed is:

1. A portable solar power and battery charger system comprising:
a charger comprising
a power sensing circuit;
at least one battery charging circuit electrically coupled with said power sensing circuit wherein said at least one battery charging circuit is configured to electrically couple with at least one battery respectively;
a summed voltage bus coupled with said at least one battery charging circuit wherein said summed voltage bus is configured to enable said at least one battery to provide power in case of loss of solar power;
a second power sensing circuit electrically coupled with said summed voltage bus;
a direct current to direct current switching voltage regulator coupled with said summed voltage bus;
at least one processor coupled with said direct current to direct current switching voltage regulator wherein said at least one processor is configured to control said direct current to direct current switching voltage regulator; and,
a foldable solar panel configured to coupled with said charger and configured to fit in a single compartment along with said charger.

2. The portable solar power and battery charger system of claim 1 further comprising:
a temperature sensor configured to provide a temperature value wherein said at least one processor is configured to control said at least one battery charging circuit based on said temperature value.

3. The portable solar power and battery charger system of claim 1 further comprising:
at least one GPS receiver coupled with said at least one processor;
an interface configured to couple with a solar panel that comprises
at least one magnetometer and
at least one inclinometer; and,
said at least one processor configured to utilize time and position information from said at least one GPS receiver, and orientation information from said at least one magnetometer and declination information from said at least one inclinometer in order to orient and incline said solar panel for maximum power.

4. The portable solar power and battery charger system of claim 1 wherein said at least one processor is further configured to charge said at least one battery to maximize a battery life associated with said at least one battery.

5. The portable solar power and battery charger system of claim 1 further comprising a user interface coupled with said at least one processor and configured to display projected battery life.

6. The portable solar power and battery charger system of claim 1 further comprising a user interface coupled with said at least one processor and configured to accept a desired output voltage.

7. The portable solar power and battery charger system of claim 1 wherein said direct current to direct current switching voltage regulator is external to said charger to lessen heat generated within said charger.

8. The portable solar power and battery charger system of claim 1 wherein said at least one processor is further configured to prioritize use of a plurality of power sources coupled with said charger.

9. A portable solar power and battery charger system comprising:
a charger comprising
a power sensing circuit;
at least one battery charging circuit electrically coupled with said power sensing circuit wherein said at least one battery charging circuit is configured to electrically couple with at least one battery respectively;
a summed voltage bus coupled with said at least one battery charging circuit wherein said summed voltage bus is configured to enable said at least one battery to provide power in case of loss of solar power;
a second power sensing circuit electrically coupled with said summed voltage bus;
a direct current to direct current switching voltage regulator coupled with said summed voltage bus;
at least one processor coupled with said direct current to direct current switching voltage regulator wherein said at least one processor is configured to control said direct current to direct current switching voltage regulator;
a foldable solar panel configured to coupled with said charger and configured to fit in a single compartment along with said charger;
at least one GPS receiver coupled with said at least one processor;
an interface configured to couple with a solar panel that comprises
at least one magnetometer and
at least one inclinometer; and,
said at least one processor configured to utilize time and position information from said at least one GPS receiver, and orientation information from said at least one magnetometer and declination information from said at least one inclinometer in order to orient and incline said solar panel for maximum power.

10. The portable solar power and battery charger system of claim 9 further comprising:
a temperature sensor configured to provide a temperature value wherein said at least one processor is configured to control said at least one battery charging circuit based on said temperature value.

11. The portable solar power and battery charger system of claim 9 wherein said at least one processor is further configured to charge said at least one battery to maximize a battery life associated with said at least one battery.

12. The portable solar power and battery charger system of claim 9 further comprising a user interface coupled with said at least one processor and configured to display projected battery life.

13. The portable solar power and battery charger system of claim 9 further comprising a user interface coupled with said at least one processor and configured to accept a desired output voltage.

14. The portable solar power and battery charger system of claim 9 wherein said direct current to direct current switching voltage regulator is external to said charger to lessen heat generated within said charger.

15. The portable solar power and battery charger system of claim 9 wherein said at least one processor is further configured to prioritize use of a plurality of power sources coupled with said charger.

16. A portable solar power and battery charger system comprising:
a charger comprising
a power sensing circuit;
at least one battery charging circuit electrically coupled with said power sensing circuit wherein said at least one battery charging circuit is configured to electrically couple with at least one battery respectively;
a summed voltage bus coupled with said at least one battery charging circuit wherein said summed voltage bus is configured to enable said at least one battery to provide power in case of loss of solar power;
a second power sensing circuit electrically coupled with said summed voltage bus;
a direct current to direct current switching voltage regulator coupled with said summed voltage bus;
at least one processor coupled with said direct current to direct current switching voltage regulator wherein said at least one processor is configured to control said direct current to direct current switching voltage regulator;
a foldable solar panel configured to coupled with said charger and configured to fit in a single compartment along with said charger;
at least one GPS receiver coupled with said at least one processor;
an interface configured to couple with a solar panel that comprises
at least one magnetometer and
at least one inclinometer;
wherein said direct current to direct current switching voltage regulator is external to said charger to lessen heat generated within said charger;
said at least one processor configured to utilize time and position information from said at least one GPS receiver, and orientation information from said at least one magnetometer and declination information from said at least one inclinometer in order to orient and incline said solar panel for maximum power; and,
wherein said at least one processor is further configured to prioritize use of a plurality of power sources coupled with said charger.

17. The portable solar power and battery charger system of claim 16 further comprising:
a temperature sensor configured to provide a temperature value wherein said at least one processor is configured to control said at least one battery charging circuit based on said temperature value.

18. The portable solar power and battery charger system of claim 16 wherein said at least one processor is further configured to charge said at least one battery to maximize a battery life associated with said at least one battery.

19. The portable solar power and battery charger system of claim 16 further comprising a user interface coupled with said at least one processor and configured to display projected battery life.

20. The portable solar power and battery charger system of claim 16 further comprising a user interface coupled with said at least one processor and configured to accept a desired output voltage.
